(19) United States
(12) Patent Application Publication
(10) Pub. No.: US 2004/0107390 A1
(43) Pub. Date: Jun. 3, 2004

(54) Timing adjustment circuit, drive circuit, electrooptic device and electronic equipment

(75) Inventor: Shin Fujita, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/629,590

(22) Filed: Jul. 30, 2003

(30) Foreign Application Priority Data
Aug. 9, 2002 (JP) 2002-233881

(51) Int. Cl. G06F 11/00

(52) U.S. Cl. 714/701

(57) ABSTRACT

To facilitate the estimation of the delay time between an input and an output. Inverters INV1 and INV4 generate a reference signal R and a signal to-be-corrected H on the basis of an input positive-logic signal Pin and an input negative-logic signal Nin. Since the reference signal R is transferred through a wiring line Lp, it undergoes no delay in the process of the transfer. On the other hand, the signal to-be-corrected H undergoes the influence of the reference signal R and has its phase corrected by a NAND circuit 11 and a NOR circuit 12.

### BACKGROUND OF THE INVENTION

1. Field of Invention

The present invention relates to a timing adjustment circuit, a drive circuit, an electro-optic device and an electronic equipment in which an output positive-logic signal and an output negative-logic signal are generated with the phase difference between an input positive-logic signal and an input negative-logic signal decreased.

2. Description of Related Art

In an electronic circuit, signal processing is sometimes executed using a positive logic signal which becomes active at its high level, and a negative logic signal which is obtained by inverting the positive logic signal. A typical electronic circuit is a shift register in which input pulses are sequentially shifted using a clock signal and an inverted clock signal.

Regarding the electronic circuit which operates with the signals of two phases in this manner, it is ideal that no delay is involved between the positive logic signal and the negative logic signal. It is often the case, however, that a delay develops between both the signals on account of the generation processes of the positive logic signal and negative logic signal, the routing of wiring lines, etc. By way of example, when an inverter is employed for generating a negative logic signal from one positive logic signal, the negative logic signal delays the propagation delay time of the inverter relative to the positive logic signal.

Moreover, assuming that the positive logic signal and the negative logic signal having no delay therebetween have been generated, one signal delays relative to the other signal under the influence of wiring capacitances when wiring distances or paths from a generation circuit to circuits employing these signals are different.

Therefore, a timing adjustment circuit shown in FIG. 12 is sometimes employed in order to shorten the delay time between the positive logic signal and the negative logic signal. The timing adjustment circuit includes six inverters INV1-INV6. Herein, an input positive-logic signal Pin is fed to the inverter TW1, while an input negative-logic signal Nin is fed to the inverter INV4. The inverters INV1-INV4 function as buffer circuits, and an output positive-logic signal Pout is delivered from the inverter INV2, while an output negative-logic signal Nout is delivered from the inverter INV3. Besides, the inverters INV5 and INV5 are connected in inverse senses between wiring lines Lp and Ln.

FIG. 13 is a timing chart showing the operation of the conventional timing adjustment circuit. In this example, it is assumed that the input negative-logic signal Nin delays a time period T relative to the input positive-logic signal Pin. (A) indicated in the figure designates the output signal P1 of the inverter INV1 in the case where the inverters INV1 and INV2 are respectively disconnected from the succeeding circuit at points Qp and Qn, and (B) designates the output signal N1 of the inverter INV4 in the case where the inverters INV1 and INV2 are respectively disconnected from the succeeding circuit at the points Qp and Qn. When the signals P1 and N1 are compared, it is seen that the signal N1 delays a time period T1 relative to the signal P1.

Assuming here that the inverters INV1 and INV2 are respectively connected to the succeeding circuit at the points Qp and Qn, the waveform of the signal P1 changes into a signal P1′ shown at (C) in the figure, while the waveform of the signal Q1 changes into a signal Q1′ shown at (D) in the figure.

The reason therefor is that the inverters INV5 and INV6 are connected in the shape of a ring between the wiring lines Lp and Ln, so the output signal of the inverter INV6 and the output signal of the inverter INV1 are synthesized on the wiring line Lp, while the output signal of the inverter INV5 and the output signal of the inverter INV4 are synthesized on the wiring line Ln. More specifically, one signal and the other signal influence each other on each of the wiring lines Lp and Ln, and the output timing of the resulting signal is delayed, whereby the timings of both the signals P1 and N1 are adjusted. As a result, the phase difference between the signals P1′ and Q1′ becomes a time period T2, which is shorter than the time period T1.

In the conventional timing adjustment circuit, however, when the signals pass through the inverters INV5 and INV6, delays develop inevitably, so that delays are inevitably involved before and after the inverters INV1 and NV2 are respectively connected with the succeeding circuit at the points Qp and Qn.

By way of example, when note is taken of the trailing edge PE1′ of the corrected signal P1′, this trailing edge PE1′ is obtained in such a way that the trailing edge PE1 of the signal P1, and a signal resulting from the inversion of the leading edge QE1 of the signal Q1 by the inverter INV6 are synthesized. Therefore, the trailing edge PE1′ delays a time period t1 relative to the trailing edge PE1 of the signal P1.

Herein, the delay time t1 is determined depending upon the characteristics of transistors constituting the inverters INV1 and INV4-INV6, the phase difference between the input positive-logic signal Pin and the input negative-logic signal Nin, and so forth. It is accordingly difficult to estimate the delay time t1 beforehand.

The design of a digital system is usually performed by considering the delays of signals so as not to give rise to malfunctions. In this case, it is necessitated to estimate the delay times of individual circuits. Since, as stated above, the estimations of the delay times are difficult in the conventional timing adjustment circuit, there has been the problem that the system design is hampered and is inconvenienced.

The present invention has been made in view of the above circumstances, and has for its object to provide a timing adjustment circuit whose delay times can be estimated.

### SUMMARY OF THE INVENTION

In order to solve the problem, a timing adjustment circuit according to the present invention is one which is fed with an input positive-logic signal that is asserted at its high level, and an input negative-logic signal that is asserted at its low level, and which generates an output positive-logic signal and an output negative-logic signal that have their phase difference decreased, characterized by comprising a signal generation portion which generates a reference signal on the basis of either of the input positive-logic signal and the input negative-logic signal, and which generates a signal to-be-corrected on the basis of the other signal; and a correction portion which corrects the signal to-be-corrected on the basis of the reference signal; wherein the reference signal delivered as one of the output positive-logic signal and the output negative-logic signal, while a signal obtained by correcting the signal to-be-corrected by means of the first correction circuit and the second correction circuit is delivered as the other of the output positive-logic signal and the output negative-logic signal.

In accordance with this invention, the signal to-be-corrected is corrected on the basis of the reference signal, while the reference signal is outputted as it is, so that the reference signal is not delayed. It is accordingly permitted to easily estimate the delay times of the output positive-logic signal and the output negative-logic signal. As a result, it is facilitated to design a digital system in which the timing adjustment circuit is incorporated.

Here, the correction portion should desirably include a first correction portion which corrects a timing of a trailing edge of the signal to-be-corrected on the basis of a leading edge of the reference signal; and a second correction portion which corrects a timing of a leading edge of the signal to-be-corrected on the basis of a trailing edge of the reference signal. In accordance with this invention, the rise of the reference signal and the fall of the signal to-be-corrected can be properly arranged, and the fall of the reference signal and the rise of the signal to-be-corrected can be properly arranged.

Concretely, it is favorable that either of the first correction portion and the second correction portion is a NAND circuit, while the other is a NOR circuit. Further, in the case where the NAND circuit and the NOR circuit are included, the timing adjustment circuit should preferably comprise a first wiring line which is fed with the reference signal; and a second wiring line which is fed with the signal to-be-corrected; wherein one input terminal of the NAND circuit is connected to the first wiring line, while the other input terminal thereof is connected to the second wiring line, and an output terminal of the NAND circuit is connected to the second wiring line; and one input terminal of the NOR circuit is connected to the first wiring line, while the other input terminal thereof is connected to the second wiring line, and an output terminal of the NOR circuit is connected to the second wiring line.

Besides, the reference signal may well advance in phase relative to the signal to-be-corrected. In that case, if the reference signal is asserted at its high level, while the signal to-be-corrected is asserted at its low level, it is favorable that the first correction circuit is the NAND circuit and that the second correction circuit is the NOR circuit. Further, the reference signal may well advance in phase relative to the signal to-be-corrected. In that case, it is favorable that the reference signal is asserted at its low level, while the signal to-be-corrected is asserted at its high level, wherein the first correction circuit is the NOR circuit, and the second correction circuit is the NAND circuit.

In contrast, the reference signal may well retard in phase relative to the signal to-be-corrected. In that case, if the reference signal is asserted at its high level, while the signal to-be-corrected is asserted at its low level, it is favorable that the first correction circuit is the NOR circuit and that the second correction circuit is the NAND circuit. Further, the reference signal may well retard in phase relative to the signal to-be-corrected. In that case, if the reference signal is asserted at its low level, while the signal to-be-corrected is asserted at its high level, it is favorable that the first correction circuit is the NAND circuit, and that the second correction circuit is the NOR circuit.

Next, in the timing adjustment circuit described above, the signal generation portion should preferably include a first inversion circuit which inverts either of the input positive-logic signal and the input negative-logic signal, thereby to generate the reference signal, and a second inversion circuit which inverts the other signal, thereby to generate the signal to-be-corrected. In this case, a timing adjustment circuit of 2-input and 2-output type is constructed.

Further, it is also allowed that a single input signal is fed to the signal generation portion instead of the input positive-logic signal and the input negative-logic signal, and that the signal generation portion generates the reference signal and the signal to-be-corrected on the basis of the input signal. In this case, a timing adjustment circuit of 1-input and 2-output type is constructed.

More concretely, the signal generation portion may include a first inversion circuit which inverts the input signal at least once, thereby to generate the reference signal; and a second inversion circuit which inverts the input signal more than the number of times of inversion of the first inversion circuit, thereby to generate the signal to-be-corrected. By way of example, it is also allowed to construct the first inversion circuit with one inverter, and to construct the second inversion circuit with two inverters.

Next, a drive circuit according to the present invention should preferably be one which drives an electrooptic device having a plurality of scanning lines, a plurality of data lines, and pixel electrodes and switching elements that are arranged in the shape of a matrix in correspondence with intersections between the scanning lines and the data lines, comprising the timing adjustment circuit as described above, wherein the timing of a predetermined signal is adjusted using the timing adjustment circuit. The drive circuit covers, for example, a data-line drive circuit and a scanning-line drive circuit.

Next, an electrooptic device according to the present invention comprises a plurality of scanning lines; a plurality of data lines; pixel electrodes and switching elements which are arranged in the shape of a matrix in correspondence with intersections between the scanning lines and the data lines; and the drive circuit as described above. In accordance with the electro-optic device, the estimation of a delay time in the drive circuit is easy, and hence, a design free from a malfunction can be facilitated.

Next, an electronic equipment according to the present invention is characterized by comprising the electro-optic device as described above, and a view finder for use in a video camera, a portable telephone, a notebook type computer or a video projector, for example, corresponds to the electronic equipment.

### BRIEF DESCRIPTION OF THE DRAWINGS

A block diagram showing the general construction of a liquid crystal panel AA according to the present invention.

FIG. 1 is a circuit diagram showing the arrangement of a timing adjustment circuit 10 according to the present invention.

FIG. 2 is a timing chart showing an operating example of the timing adjustment circuit 10.

FIG. 3 is a timing chart showing another operating example of the timing adjustment circuit 10.

FIG. 4 is a timing chart showing another operating example of the timing adjustment circuit 10.

FIG. 5 is a timing chart showing another operating example of the timing adjustment circuit 10.

FIG. 6 is a circuit diagram of a timing adjustment circuit 20 which has another example of arrangement.

FIG. 7 is a block diagram showing the construction of a liquid crystal device according to the present invention.

FIG. 8 is a block diagram showing the arrangement of the data-line drive circuit 200 of the liquid crystal device.

FIG. 9 is a sectional view of a video projector which is an example of electronic equipment applying the liquid crystal device.

FIG. 10 is a perspective view showing the construction of a personal computer which is an example of electronic equipment applying the liquid crystal device.

FIG. 11 is a perspective view showing the construction of a portable telephone which is an example of electronic equipment applying the liquid crystal device.

FIG. 12 is a circuit diagram showing the arrangement of a conventional timing adjustment circuit.

FIG. 13 is a timing chart showing the operation of the conventional timing adjustment circuit.

### DETAILED DESCRIPTION OF PREFERRED EMBODIMENTS

Now, embodiments of the present invention will be described with reference to the drawings.

<1: Arrangement of Timing Adjustment Circuit>

FIG. 1 is a circuit diagram of a timing adjustment circuit 10. The timing adjustment circuit 10 shown in the figure includes four inverters INV1-INV4, a NAND circuit 11 and a NOR circuit 12.

The inverter INV1 inverts an input positive-logic signal Pin and outputs the resulting signal as a reference signal R, while the inverter INV2 inverts an input negative-logic signal Nin and outputs the resulting signal as a signal to-be-corrected H.

The output terminal of the inverter INV1 is connected with the input terminal of the inverter INV2 through a wiring line Lp, and the output terminal of the inverter INV4 is connected with the input terminal of the inverter INV3 through a wiring line Ln. While an output positive-logic signal Pout is delivered from the inverter INV2, an output negative-logic signal Nout is delivered from the inverter INV3.

One input terminal of the NAND circuit 11 is connected to the wiring line Lp, the other input terminal thereof to the wiring line Ln, and the output terminal thereof to the wiring line Ln. Besides, one input terminal of the NOR circuit 12 is connected to the wiring line Lp, the other input terminal thereof to the wiring line Ln, and the output terminal thereof to the wiring line Ln.

In such an arrangement, the inverters INV1 and INV4 function as a signal generation portion which generates the reference signal R and the signal to-be-corrected H on the basis of the input positive-logic signal Pin and the input negative-logic signal Nin, respectively.

Besides, since the reference signal R is transferred through the wiring line Lp, it undergoes no delay in the process of the transfer. On the other hand, the signal to-be-corrected H undergoes the influence of the reference signal R on account of the NAND circuit 11 and the NOR circuit 12 so as to have its phase corrected. In other words, the reference signal R is transferred without being influenced by the signal to-be-corrected H, and only the signal to-be-corrected H is corrected on the basis of the reference signal R. By the way, in the timing adjustment circuit 10 shown in FIG. 1, a part enclosed with a broken line is a portion concerning the corrections of timings. As the invention, therefore, the inverters INV1 and INV4 and the part enclosed with the broken line may well be grasped as the timing adjustment circuit, the part enclosed with the broken line and the inverters INV2 and INV3 may well be grasped as the timing adjustment circuit, or only the part enclosed with the broken line may well be grasped as the timing adjustment circuit.

<2: Operation of Timing Adjustment Circuit>

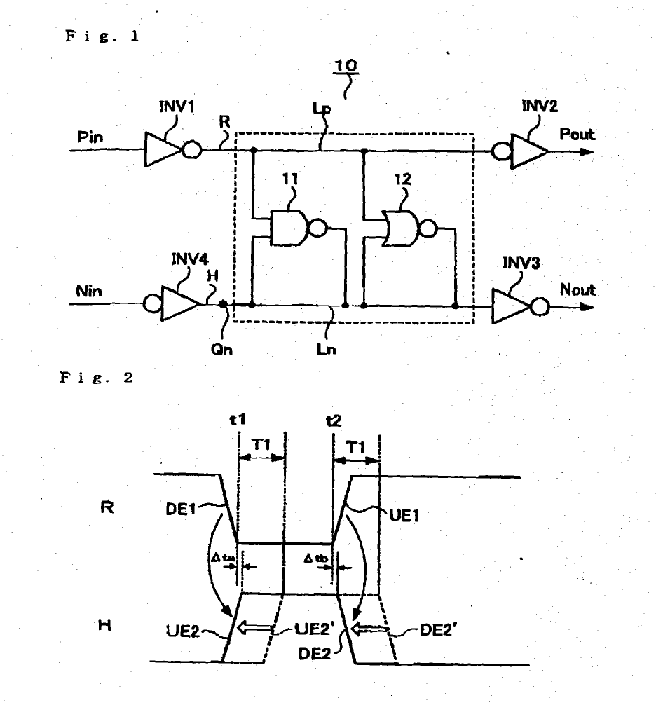

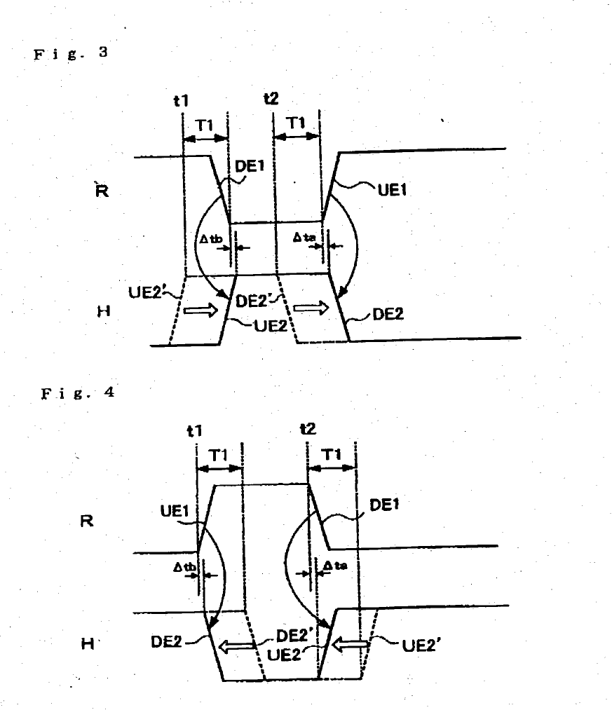

Next, the operation of the timing adjustment circuit will be described. FIG. 2 is a timing chart for explaining the operation of the timing adjustment circuit 10. In this example, it is assumed that the input negative-logic signal Nin delays a time period T1 relative to the input positive-logic signal Pin. More specifically, the reference signal R becomes active at its low level, and it advances in phase relative to the signal to-be-corrected H.

In the waveform of the illustrated signal to-be-corrected H, a waveform indicated by broken lines is the waveform thereof in the case where the inverter INV4 is disconnected from the succeeding circuit at a point Qn.

When the logic level of the reference signal R has shifted from the high level to the low level at a time t1, both the input signals of the NOR circuit 12 become the low level, and hence, the output signal thereof becomes the high level. Assuming here that the propagation delay time of the NOR circuit 12 is Ata, the signal to-be-corrected H shifts from the low level to the high level at a time (t1+ta). That is, in this example, the NOR circuit 12 functions as a correction circuit which corrects the leading edge UE1 of the signal to-be-corrected H on the basis of the trailing edge DE1 of the reference signal R.

When the reference signal R has shifted from the low level to the high level at a time t2, both the input signals of the NAND circuit 11 become the high level, and hence, the output signal thereof becomes the low level. Assuming here that the propagation delay time of the NAND circuit 11 is Δtb, the signal to-be-corrected H shifts from the high level to the low level at a time (t2+tb). That is, in this example, the NAND circuit 11 functions as a correction circuit which corrects the trailing edge DE2 of the signal to-be-corrected H on the basis of the leading edge UE1 of the reference signal R.

In this manner, the leading edge UE2′ before the correction can be advanced a time period (T1−Δta) so as to be brought into a leading edge UE2 after the correction, and the trailing edge DE2′ before the correction can be advanced a time period (T1−Δtb) so as to generate a trailing edge DE2 after the correction.

Accordingly, the phase of the signal to-be-corrected H can be corrected with no delay of the reference signal R. That is, a time period in which the input positive-logic signal Pin corresponding to the reference signal R is delivered as the output positive-logic signal Pout after being fed to the timing adjustment circuit 10 is determined merely by the total of the propagation delay times of the inverters INV1 and INV2. Besides, the output negative-logic signal Nout delays a predetermined time period from the output positive-logic signal Pout, irrespective of the phase difference between the input negative-logic signal Nin and the input positive-logic signal Pin. Assuming here that the propagation delay times of the inverters INV1-INV4 are equal, and that the delay time Δtb of the NAND circuit 11 is equal to the delay time Δta of the NOR circuit 12, the output negative-logic signal Nout delays the time period Ata as compared with the output positive-logic signal Pout.

In accordance with the timing adjustment circuit 10, accordingly, the delay times can be easily estimated, so that even when incorporated as part of a digital system, the timing adjustment circuit 10 permits the whole system to be stably operated.

Next, there will be described a case where the reference signal R becomes active at its low level, and where the reference signal R retards in phase relative to the signal to-be-corrected H. FIG. 3 shows a timing chart of the timing adjustment circuit 10.

In this case, when the logic level of the signal to-be-corrected H has shifted from the low level to the high level at a time t1, both the input signals of the NAND circuit 11 become the high level, and hence, the output signal thereof becomes the low level. Accordingly, the NAND circuit 11 functions as a correction circuit which corrects the leading edge UE1′ of the signal to-be-corrected H to generate a leading edge UE1, on the basis of the trailing edge DE1 of the reference signal R.

Besides, when the reference signal R has shifted from the high level to the low level at a time t2, both the input signals of the NOR circuit 12 become the low level, and hence, the output signal thereof becomes the high level. Accordingly, the NOR circuit 12 functions as a correction circuit which corrects the trailing edge DE2′ of the signal to-be-corrected H to generate a trailing edge DE2, on the basis of the leading edge UE1 of the reference signal R.

Next, there will be described a case where the input negative-logic signal Nin is fed to the inverter INV1, while the input positive-logic signal Pin is fed to the inverter INV4, and where the input negative-logic signal Nin advances in phase relative to the input positive-logic signal Pin. In this case, the reference signal R becomes active at its high level, and the signal to-be-corrected H becomes active at its low level. FIG. 4 shows a timing chart of the timing adjustment circuit 10.

In this case, when the logic level of the reference signal R has shifted from the low level to the high level at a time t1, both the input signals of the NAND circuit 11 become the high level, and hence, the output signal thereof becomes the low level. Accordingly, the NAND circuit 11 functions as a correction circuit which corrects the trailing edge DE2′ of the signal to-be-corrected H to generate a trailing edge DE2, on the basis of the leading edge UE1 of the reference signal R.

Besides, when the reference signal R has shifted from the high level to the low level at a time t2, both the input signals of the NOR circuit 12 become the low level, and hence, the output signal thereof becomes the high level. Accordingly, the NOR circuit 12 functions as a correction circuit which corrects the leading edge UE2′ of the signal to-be-corrected H to generate a leading edge UE2, on the basis of the trailing edge DE1 of the reference signal R.

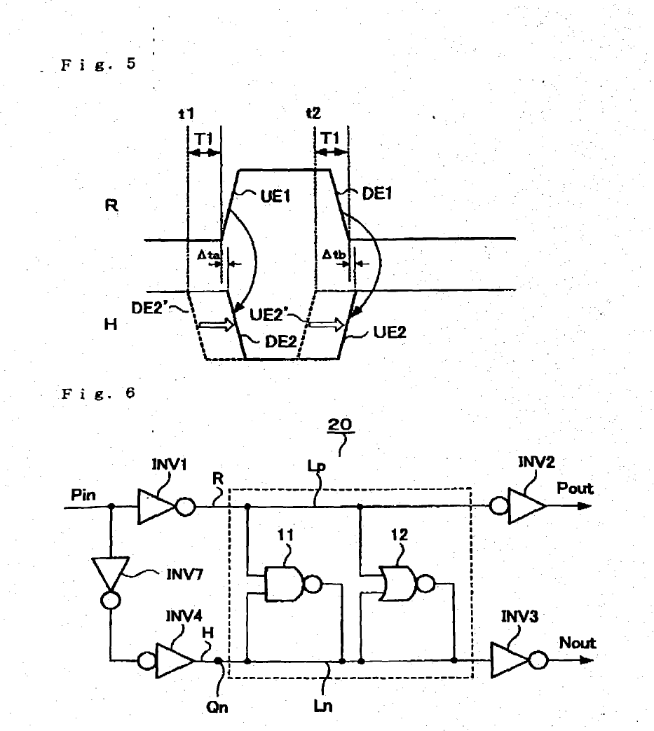

Next, there will be described a case where the input negative-logic signal Nin is fed to the inverter INV1, while the input positive-logic signal Pin is fed to the inverter INV4, and where the input negative-logic signal Nin retards in phase relative to the input positive-logic signal Pin. In this case, the reference signal R becomes active at its low level, and the signal to-be-corrected H becomes active at its high level. FIG. 5 shows a timing chart of the timing adjustment circuit 10.

In this case, when the logic level of the signal to-be-corrected H is about to shift from the high level to the low level at a time t1, both the input signals of the NOR circuit 12 become the low level, and hence, the output signal thereof becomes the high level. Accordingly, the NOR circuit 12 functions as a correction circuit which corrects the trailing edge DE2′ of the signal to-be-corrected H to generate a trailing edge DE2, on the basis of the leading edge UE1 of the reference signal R.

Besides, when the signal to-be-corrected H is about to shift from the low level to the high level at a time t2, both the input signals of the NAND circuit 11 become the high level, and hence, the output signal thereof becomes the low level. Accordingly, the NAND circuit 11 functions as a correction circuit which corrects the leading edge UE2′ of the signal to-be-corrected H to generate a leading edge UE2, on the basis of the trailing edge DE1 of the reference signal R.

<3: Another Example of Arrangement of Timing Adjustment Circuit>

Next, another example of the arrangement of a timing adjustment circuit will be described. Whereas the timing adjustment circuit 10 described above is of 2-input and 2-output type, the arrangement example here is of 1-input and 2-output type. FIG. 6 shows a circuit diagram of the timing adjustment circuit 20. The timing adjustment circuit 20 is such that an inverter INV7 is interposed between the input terminal of an inverter INV1 and the input terminal of an inverter INV4, and that an input positive-logic signal Pin is inverted by the inverter INV7 so as to feed the resulting signal to the inverter INV4.

Accordingly, the input signal of the inverter INV4 delays with the propagation delay time of the inverter INV7 relative to the input positive-logic signal Pin. The correcting operation of the timing adjustment circuit 20 is similar to the operation of the timing adjustment circuit 10 as shown in FIG. 2. Besides, the correcting operation of the timing adjustment circuit 20 in the case where an input negative-logic signal Nin is fed to the inverter INV1 is similar to the operation of the timing adjustment circuit 10 as shown in FIG. 4.

In accordance with the timing adjustment circuit 20, output signals of two phases in the relationship of positive and negative logic can be generated on the basis of the input signal of the single phase, and delay times can be easily estimated with reference to the input signal. As a result, even when incorporated as part of a digital system, the timing adjustment circuit 20 permits the whole system to be stably operated.

<4: Liquid Crystal Device>

Next, there will be described an example in which the timing adjustment circuit 10 or 20 described above is applied to a liquid crystal device. The liquid crystal device is an electrooptic device which employs a liquid crystal as an electrooptic material. This liquid crystal device includes a liquid crystal panel AA as its principal part. The liquid crystal panel AA is such that an element substrate formed with thin film transistors (hereinbelow, termed “TFTs”) as switching elements, and an opposite substrate are stuck with their electrode formation surfaces opposed to each other, and with a predetermined gap held therebetween, and that the liquid crystal is held in the gap.

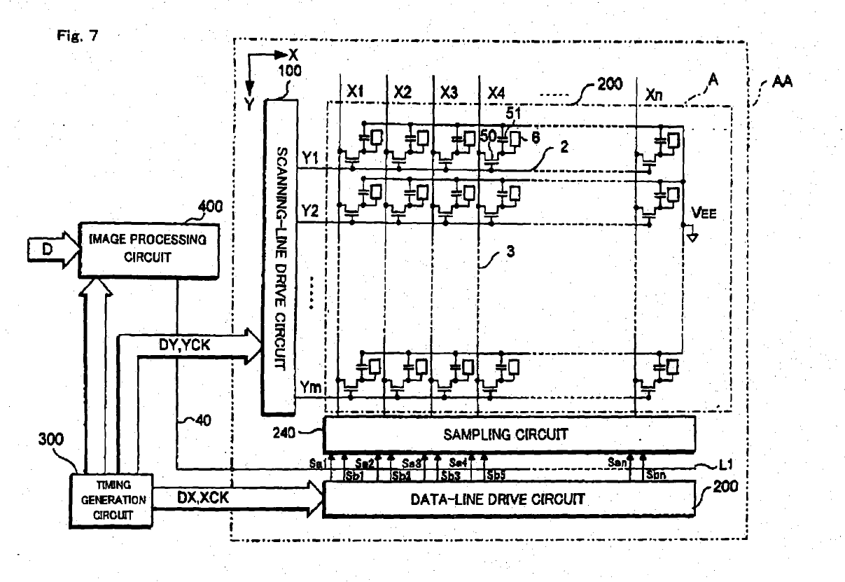

FIG. 7 is a block diagram showing the general construction of the liquid crystal device according to an embodiment. This liquid crystal device includes the liquid crystal panel AA, a timing generation circuit 300 and an image processing circuit 400. The liquid crystal panel AA includes an image display region A, a scanning-line drive circuit 100, a data-line drive circuit 200, a sampling circuit 240 and an image-signal feed line L1 on the element substrate. In this example, the timing adjustment circuits 10 and 20 described above are incorporated in the data-line drive circuit 200.

Input image data D which is fed to the liquid crystal device is in a 3-bit parallel form by way of example. The timing generation circuit 300 generates a Y clock signal YCK, an X clock signal XCK, a Y-transfer start pulse DY and an X-transfer start pulse DX in synchronism with the input image data D, so as to feed the generated signals to the scanning-line drive circuit 100 and the data-line drive circuit 200. Besides, the timing generation circuit 300 generates and outputs various timing signals for controlling the image processing circuit 400.

Here, the Y clock signal YCK is a signal for specifying a time period for which each scanning line 2 is selected. The X clock signal XCK specifies a time period for which each data line 3 is selected. Besides, the Y-transfer start pulse DY is a pulse for commanding the selection start of the scanning line 2, while the X-transfer start pulse DX is a pulse for commanding the selection start of the data line 3.

The image processing circuit 400 subjects the input image data D to gamma corrections in which the light transmission characteristic of the liquid crystal panel is considered, etc., and thereafter D/A-converts the image data, thereby to generate an image signal 40 which is fed to the liquid crystal panel AA. Incidentally, although this example is assumed to represent the black-and-white gradations of the image signal 40 for the brevity of description, the present invention is not restricted thereto, but the image signal 40 may well be formed of an R signal, a G signal and a B signal corresponding to respective colors R, G and B. In this case, image-signal feed lines may be laid in the number of 3.

Subsequently, in the image display region A, as shown in FIG. 7, m (a natural number of at least 2) scanning lines 2 are formed so as to be arrayed in parallel in a direction X, while n (a natural number of at least 2) data lines 3 are formed so as to be arrayed in parallel in a direction Y. Besides, near the intersection between each scanning line 2 and each data line 3, the gate of the TFT 50 is connected to the scanning line 2, while the source of the TFT 50 is connected to the data line 3 and the drain of the TFT 50 is connected to a pixel electrode 6. In addition, each pixel is constituted by the pixel electrode 6, a counter electrode formed on the opposite substrate, and the liquid crystal held between these electrodes. As a result, the pixels are arrayed in the shape of a matrix in correspondence with the respective intersections between the scanning lines 2 and the data lines 3.

Besides, scanning signals Y1, Y2, . . . , Ym are impressed on the individual scanning lines 2 to which the gates of the TFTs 50 are connected, in line sequence in pulse fashion. Therefore, when the scanning signal is fed to a certain one of the scanning lines 2, the TFTs 50 connected to the pertinent scanning line are turned ON, so that data line signals X1, X2, . . . , Xn fed at predetermined timings from the data lines 3 are successively written into the corresponding pixels and thereafter retained for predetermined time periods.

Since the orientation and order of liquid crystal molecules change in accordance with voltage levels applied to the individual pixels, a gradational display based on light modulation can be presented. By way of example, in the normally-white mode, the quantity of light which passes through the liquid crystal is limited as an applied voltage heightens, whereas in the normally-black mode, it is moderated as the applied voltage heightens, so that light having a contrast correspondent to the image signal is emitted every pixel as the whole liquid-crystal device. Therefore, the predetermined display can be presented.

Besides, in order to prevent the retained image signal from leaking out, a storage capacitor 51 is added in parallel with a liquid crystal capacitance which is formed between each pixel electrode 6 and the counter electrode. By way of example, the voltage of the pixel electrode 6 is retained by the storage capacitor 51 for a time period, which is three orders longer than the application time period of a source voltage. A retention characteristic is accordingly improved, with the result that a high contrast ratio is realized.

Subsequently, the data-line drive circuit 200 generates sampling signals which become active sequentially, in synchronism with the X clock signal XCK. Two of the sampling signals form one set, and the sampling signals of a certain set consist of a positive sampling signal which becomes active (asserted) at its high level, and a negative sampling signal which becomes active at its low level and which is obtained by inverting the positive sampling signal. The positive sampling signals Sa1-San of the respective sets become active exclusively, and the negative sampling signals Sb1-Sbn of the respective sets become active exclusively. Concretely, the sampling signals become active in the order of Sa1, Sb1→Sa2, Sb2, → . . . San, Sbn.

The sampling circuit 240 includes n transfer gates SW1-SWn (not shown). Each of the transfer gates SW1-SWn is configured of complementary type TFTs, which are controlled by the positive sampling signals Sa1-San and negative sampling signals Sb1-Sbn. Herein, when the sampling signals Sa1-San and Sb1-Sbn become active sequentially, the respective transfer gates SW1-SWn fall into ON states sequentially. Then, the image signal 40 fed through the image-signal feed line L1 is sampled, and the sampled signals are sequentially fed to the respective data lines 3.

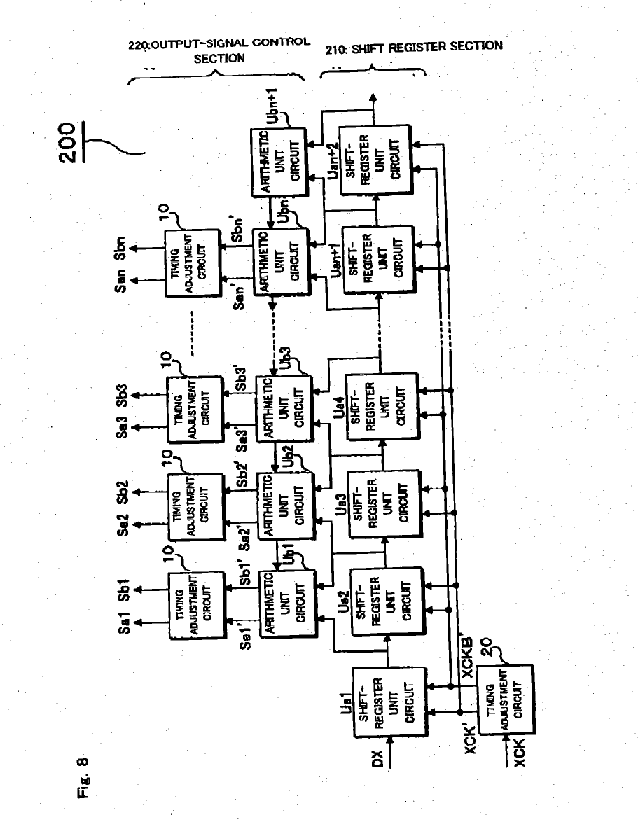

FIG. 8 is a block diagram showing the arrangement of the data-line drive circuit 200. As shown in the figure, the data-line drive circuit 200 includes the timing adjustment circuits 10 and 20 in addition to a shift register section 210 and an output-signal control section 220.

The timing adjustment circuit 20 generates an X clock signal XCK′ and an inverted X clock signal XCKB′ on the basis of the X clock signal XCK which is fed from the timing generation circuit 300.

Subsequently, the shift register section 210 includes shift-register unit circuits Ua1-Uan+2 which are connected in cascade. The shift-register unit circuits Ua1-Uan+2 transfer the start pulse DX sequentially on the basis of the X clock signal XCK′ and the inverted X clock signal XCKB′. In order to reliably transfer the start pulse DX, the phase difference between the start pulse DX and the X clock signal XCK′ as well as the inverted X clock signal XCKB′ needs to be managed. As described before, when the X clock signal XCK is taken as a reference, the delay times of the X clock signal XCK′ and the inverted X clock signal XCKB′ can be easily estimated, and hence, the timings of the start pulse DX and X clock signal XCK which are generated by the timing generation circuit 400 can be easily set.

Moreover, since only the X clock signal XCK of single phase may be fed from the timing generation circuit 400 to the liquid crystal panel AA, the number of wiring lines can be decreased, and further, electric power which is consumed for the signal drive can be curtailed.

The output-signal control section 220 includes (n+1) arithmetic unit circuits Ub1-Ubn+1. The arithmetic unit circuits Ub1-Ubn are respectively disposed in correspondence with the shift-register unit circuits Ua2-Uan+2, and they generate positive sampling signals Sa1′-San′ and negative sampling signals Sb1′-Sbn′ on the basis of the output signals of the shift-register unit circuits Ua1-Uan+2 and those of the arithmetic unit circuits Ub1-Ubn at the succeeding stages.

The positive sampling signals Sa1′-San′ and the negative sampling signals Sb1′-Sbn′ are signals which are in the relationship of positive and negative logic, but whose phases deviate each other to some extent.

The individual timing adjustment circuits 10 adjust the phases of the sets Sa1′ and Sb1′, Sa2′ and Sb2′, . . . , San′ and Sbn′ of the positive and negative sampling signals, thereby to generate the positive sampling signals Sa1-San and the negative sampling signals Sb1-Sbn.

On this occasion, the phases of the positive sampling signal Sa1 and the negative sampling signal Sb1 are substantially in agreement, so that the transfer gate SW1 of the sampling circuit 240 can be reliably turned ON and OFF.

Moreover, the delay times of the positive sampling signals Sa1-San and negative sampling signals Sb1-Sbn can be reliably estimated, and hence, the timings thereof relative to the image signal 40 which is fed to the image-signal feed line L1 can be accurately set. As a result, it is permitted to display a vivid image of high definition.

Subsequently, the scanning-line drive circuit 100 includes the timing adjustment circuit 20, a shift register, level shifters and buffers. The timing adjustment circuit 20 generates a Y clock signal YCK′ and an inverted Y clock signal YCKB′ on the basis of the Y clock signal YCK. The shift register transfers the Y-transfer start pulse DY and generates signals which become active sequentially, in synchronism with the Y clock signal YCK′ and the inverted Y clock signal YCKB′. Besides, each output signal of the shift register is subjected to level conversion by the level shifter and to current amplification by the buffer so as to be capable of controlling the ON/OFF of the TFTs 50, thereby to be fed to the corresponding scanning line 2 as each of the scanning signals Y1-Ym.

The timings of the Y-transfer start pulse DY and Y clock signal YCK which are generated by the timing generation circuit 400 can be easily set by incorporating the timing adjustment circuit 20 into the scanning-line drive circuit 100. Moreover, since only the Y clock signal YCK of single phase may be fed from the timing generation circuit 400 to the liquid crystal panel AA, the number of wiring lines can be decreased, and further, electric power which is consumed for the signal drive can be curtailed.

Incidentally, although this example has been described as the liquid-crystal display device of active matrix type, the invention is not restricted thereto, but it is also applicable to a passive type employing an STN (Super Twisted Nematic) liquid crystal or the like. Further, the invention is not restricted to the liquid crystal as the electro-optic material, but it is also applicable to a display device which employs electroluminescent elements so as to present a display by the electro-optic effect thereof. That is, the present invention is applicable to any electro-optic device which has a construction similar to that of the liquid crystal device described above.

<5: Electronic Equipment>

Next, there will be described cases where the liquid crystal device described above is applied to several electronic equipment.

<5-1: Projector>

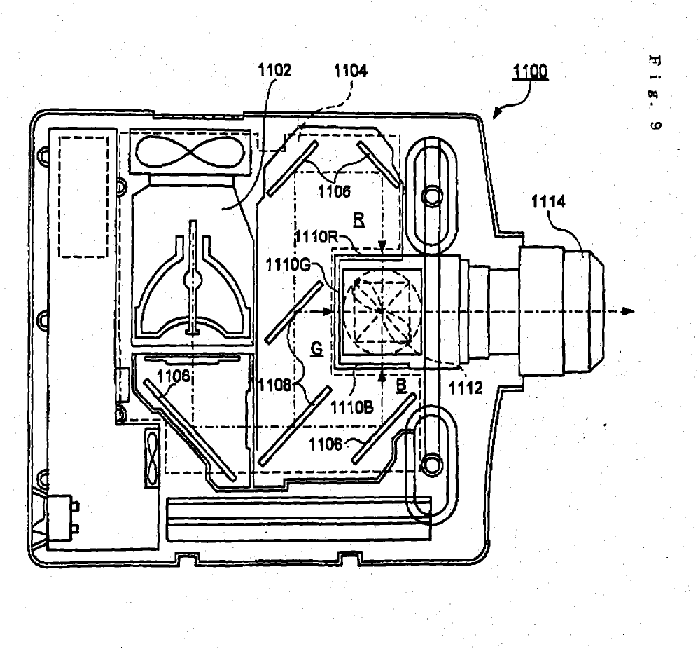

First, there will be described a projector which employs the liquid crystal device as a light valve. FIG. 9 is a plan view showing an example of construction of the projector.

As shown in the figure, a lamp unit 1102 including a white light source such as halogen lamp is disposed in the projector 1100. Projection light emitted from the lamp unit 1102 is separated into the three primary colors of R, G and B by four mirrors 1106 and two dichroic mirrors 1108 which are arranged in a light guide 1104, and the resulting lights are entered into liquid crystal panels 1110R, 1110B and 1110G which are the light valves corresponding to the respective primary colors.

The liquid crystal panels 111 OR, 1110B and 1110G have constructions each being equivalent to the construction of the liquid crystal panel AA described before, and they are respectively driven by primary color signals R, G and B fed from an image-signal processing circuit (not shown). The lights modulated by the liquid crystal panels are entered into a dichroic prism 1112 from three directions. In the dichroic prism 1112, the lights of the colors R and B are refracted at 90 degrees, whereas the light of the color G propagates rectilinearly. The images of the respective colors are accordingly synthesized, with the result that a color image is projected on a screen or the like through a projection lens 1114.

Here, when note is taken of the display images based on the respective liquid crystal panels 1110R, 1110B and 1110G, the display image based on the liquid crystal panel 1110G needs to be bilaterally inverted with respect to the display images based on the liquid crystal panels 1110R and 1110B.

Incidentally, since the lights corresponding to the respective primary colors R, G and B are entered into the liquid crystal panels 1110R, 1110B and 1110G by the dichroic mirror 1108, color filters need not be disposed.

<5-2: Mobile Computer>

Next, there will be described an example in which the liquid crystal panel is applied to a personal computer of mobile type. FIG. 10 is a perspective view showing the construction of the personal computer. Referring to the figure, the computer 1200 is constructed of a body portion 1204 including a keyboard 1202, and a liquid-crystal display unit 1206. The liquid-crystal display unit 1206 is constructed in such a way that a back-lighting structure is added in the rear of the liquid crystal panel 1005 as described before.

<5-3: Portable Telephone>

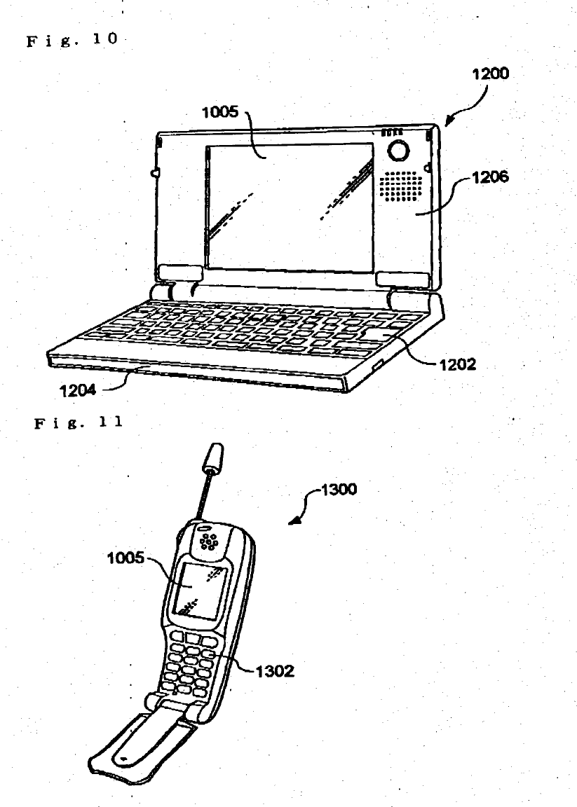

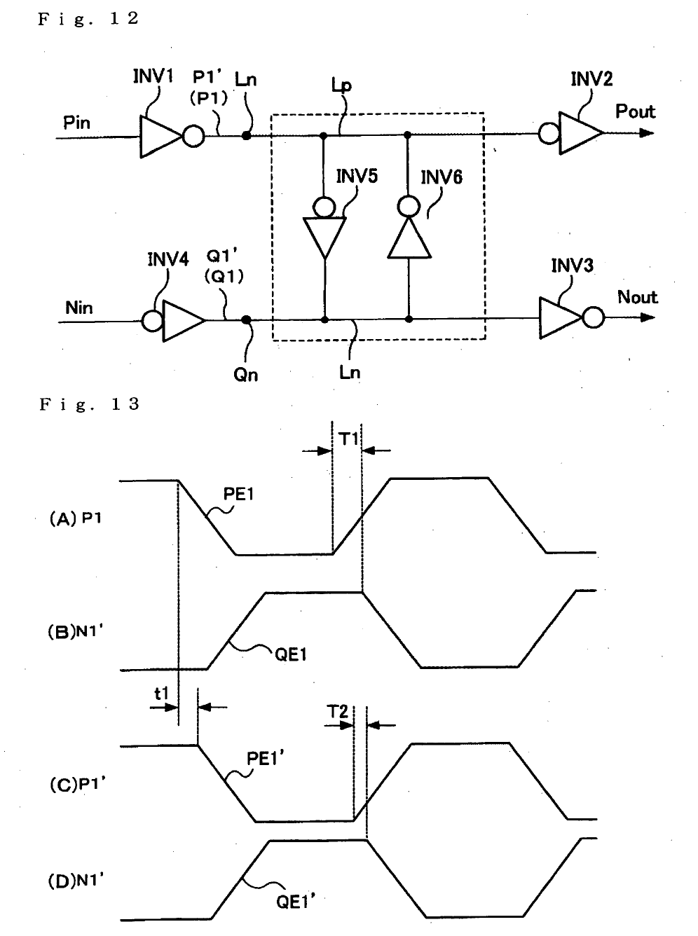

Further, there will be described an example in which the liquid crystal panel is applied to a portable telephone. FIG. 11 is a perspective view showing the construction of the portable telephone. Referring to the figure, the portable telephone 1300 includes the liquid crystal panel 1005 of reflection type together with a plurality of manipulation buttons 1302. The liquid crystal panel 1005 of reflection type is furnished with a front-lighting structure in front thereof as may be needed.

By the way, in addition to the electronic equipment described with reference to FIGS. 9-11, there are mentioned a liquid-crystal television set, a video tape recorder of view finder type or monitor direct-view type, a car navigation system, a pager, an electronic notebook, a calculator, a word processor, a workstation, a video telephone, a POS terminal, a device including a touch panel, and so forth. It is needless to say that the invention is applicable to these various electronic equipment.

As described above, according to the present invention, a signal to-be-corrected is corrected on the basis of a reference signal, and the reference signal is outputted as it is. It is, therefore, permitted to provide a timing adjustment circuit in which the delay time between an input and an output can be easily estimated.

What is claimed is:

1. A timing adjustment circuit which is fed with an input positive-logic signal that is asserted at its high level, and an input negative-logic signal that is asserted at its low level, and which generates an output positive-logic signal and an output negative-logic signal that have their phase difference decreased, characterized by comprising:
a signal generation portion which generates a reference signal on the basis of either of the input positive-logic signal and the input negative-logic signal, and which generates a signal to-be-corrected on the basis of the other signal; and
a correction portion which corrects the signal to-be-corrected on the basis of the reference signal;
wherein said reference signal is delivered as one of the output positive-logic signal and the output negative-logic signal, while a signal obtained by correcting said signal to-be-corrected by means of the first correction circuit and the second correction circuit is delivered as the other of said output positive-logic signal and said output negative-logic signal.

2. A timing adjustment circuit characterized in that said correction portion includes:
a first correction portion which corrects a timing of a trailing edge of said signal to-be-corrected on the basis of a leading edge of said reference signal; and
a second correction portion which corrects a timing of a leading edge of said signal to-be-corrected on the basis of a trailing edge of said reference signal.

3. The timing adjustment circuit as defined in claim 2, characterized in that either of said first correction portion and said second correction portion is a NAND circuit, while the other is a NOR circuit.

4. The timing adjustment circuit as defined in claim 3, characterized by comprising:
a first wiring line which is fed with said reference signal; and
a second wiring line which is fed with said signal to-be-corrected;
wherein one input terminal of said NAND circuit is connected to said first wiring line, while the other input terminal thereof is connected to said second wiring line, and an output terminal of said NAND circuit is connected to said second wiring line; and
one input terminal of said NOR circuit is connected to said first wiring line, while the other input terminal thereof is connected to said second wiring line, and an output terminal of said NOR circuit is connected to said second wiring line.

5. The timing adjustment circuit as defined in claim 2, characterized in that said reference signal advances in phase relative to said signal to-be-corrected.

6. The timing adjustment circuit as defined in claim 5, characterized in:
that said reference signal is asserted at its high level, while said signal to-be-corrected is asserted at its low level;
wherein said first correction circuit is said NAND circuit; and
said second correction circuit is said NOR circuit.

7. The timing adjustment circuit as defined in claim 5, characterized in:
that said reference signal is asserted at its low level, while said signal to-be-corrected is asserted at its high level;
wherein said first correction circuit is said NOR circuit; and
said second correction circuit is said NAND circuit.

8. The timing adjustment circuit as defined in claim 2, characterized in that said reference signal retards in phase relative to said signal to-be-corrected.

9. The timing adjustment circuit as defined in claim 8, characterized in:
that said reference signal is asserted at its high level, while said signal to-be-corrected is asserted at its low level;
wherein said first correction circuit is said NOR circuit; and
said second correction circuit is said NAND circuit.

10. The timing adjustment circuit as defined in claim 8, characterized in:
that said reference signal is asserted at its low level, while said signal to-be-corrected is asserted at its high level;
wherein said first correction circuit is said NAND circuit; and
said second correction circuit is said NOR circuit.

11. The timing adjustment circuit as defined in claim 1, characterized in that said signal generation portion includes a first inversion circuit which inverts either of said input positive-logic signal and said input negative-logic signal, thereby to generate said reference signal, and a second inversion circuit which inverts the other signal, thereby to generate said signal to-be-corrected.

12. The timing adjustment circuit as defined in claim 1, characterized in:
that a single input signal is fed to said signal generation portion instead of said input positive-logic signal and said input negative-logic signal;
wherein said signal generation portion generates said reference signal and said signal to-be-corrected on the basis of the input signal.

13. The timing adjustment circuit as defined in claim 12, characterized in that said signal generation portion includes:
a first inversion circuit which inverts said input signal at least once, thereby to generate said reference signal; and
a second inversion circuit which inverts said input signal more than the number of times of inversion of said first inversion circuit, thereby to generate said signal to-be-corrected.

14. A drive circuit which drives an electrooptic device having a plurality of scanning lines, a plurality of data lines, and pixel electrodes and switching elements that are arranged in the shape of a matrix in correspondence with intersections between the scanning lines and the data lines, characterized by comprising:
the timing adjustment circuit as defined in claim 1, wherein the timing of a predetermined signal is adjusted using said timing adjustment circuit.

15. An electrooptic device comprising:
a plurality of scanning lines;
a plurality of data lines;
pixel electrodes and switching elements which are arranged in the shape of a matrix in correspondence with intersections between said scanning lines and said data lines; and
the drive circuit as defined in claim 14.

16. An electronic equipment characterized by comprising the electrooptic device as defined in claim 15.
